(19) United States
(12) Patent Application Publication
(10) Pub. No.: US 2011/0010619 A1
(43) Pub. Date: Jan. 13, 2011

(54) Systems And Methods For Launching A User Application On A Computing Device

(76) Inventor: Craig Thomas Brown, Cypress, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/867,709

(22) PCT Filed: Apr. 8, 2008
(86) PCT No.: PCT/US08/59627

§ 371 Date: Aug. 13, 2010

(51) Int. Cl. G06F 3/01

(52) U.S. Cl. 715/702

(57) ABSTRACT

In one embodiment, a system and a method pertain to detecting user input of a symbol into a touch-sensitive input device of the computing device and, responsive to that detection, launching a user application associated with the symbol.

### BACKGROUND

User applications are normally activated or “launched” on a computer when a user selects the application using a pointing device, such as a mouse or a touchpad. For example, the user may double-click on an icon associated with the application that is displayed on the “desktop” of a graphical user interface. As a further example, the user may select the application from a list of different applications identified to the user in a start menu. In each case, an onscreen cursor must be moved to a displayed feature that identifies the application and a button must be pressed to launch the application.

Although the above launching method works reasonably well, it can be inconvenient for the user to have to position a cursor over the selectable feature using a pointing device. Therefore, more convenient methods for launching would be desirable.

### BRIEF DESCRIPTION OF THE DRAWINGS

The disclosed systems and methods can be better understood with reference to the following drawings. The components in the drawings are not necessarily to scale.

FIG. 1 is a perspective view of a first embodiment of a computing device having a touch-sensitive input device that can be used to launch a user application.

FIG. 2 is a perspective view of a second embodiment of a computing device having a touch-sensitive input device that can be used to launch a user application.

FIG. 3 is a block diagram illustrating an embodiment of architecture for the computing devices of FIGS. 1 and 2.

FIG. 4 is a flow diagram of an embodiment of a method for launching a user application on a computing device.

FIG. 5 is a schematic diagram of a user inputting a symbol into a touchpad to launch a user application.

FIG. 6 is a schematic diagram of a user inputting a symbol into a touch-sensitive display to launch a user application.

FIGS. 7A and 7B together depict a specific example of launching a user application by inputting a symbol in a touch-sensitive input device.

### DETAILED DESCRIPTION

As described above, user applications are normally activated or “launched” on a computer by moving an onscreen cursor to a displayed feature that identifies the application and then selecting the feature, for example by pressing a button. Although that launching method works reasonably well, it can be inconvenient for the user to have to position the cursor over the selectable feature with the pointing device. Disclosed herein are computing devices with which a user application can be launched by simply inputting a symbol associated with the application into a touch-sensitive input device of the computing device. In some embodiments, the symbol can be input into a touchpad of the computing device. In other embodiments, the symbol can be input into a touch-sensitive display of the computing device.

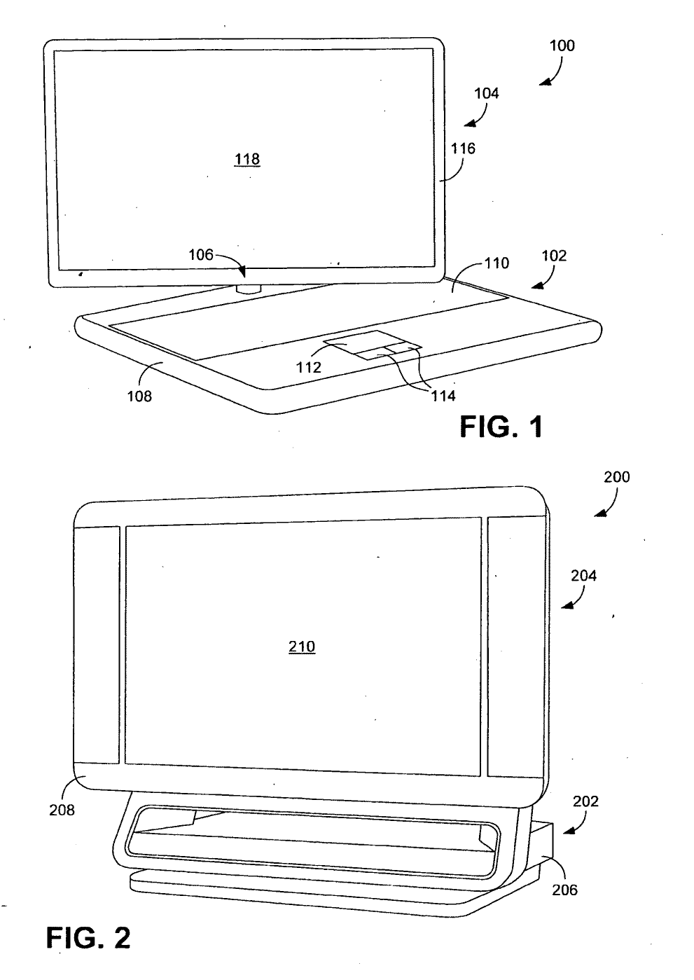

Referring now in more detail to the drawings in which like numerals indicate corresponding parts throughout the views, FIG. 1 illustrates a first computing device 100 in the form of a notebook or “laptop” computer. As indicated in FIG. 1, the computing device 100 includes a base portion 102 and a display portion 104 that are attached to each other with a hinge mechanism 106. The base portion 102 includes an outer housing 108 that surrounds various internal components of the computing device 100, such as a processor, memory, hard drive, and the like. Also included in the base portion 102 are user input devices, including a keyboard 110, a touchpad 112, and selection buttons 114. The display portion 102 includes its own outer housing 116 that supports a display 118, such as a liquid crystal display (LCD).

FIG. 2 illustrates a second computing device 200 in the form of personal or “desktop” computer. As indicated in FIG. 2, the computing device 200 includes a base portion 202 and a display portion 204 that is supported by the base portion. The base portion 202 includes an outer housing 206 that surrounds various internal components of the computing device 200, such as a processor, memory, hard drive, and the like. The display portion 202 includes its own outer housing 208 that supports a touch-sensitive display device 210, such as a touch-sensitive LCD.

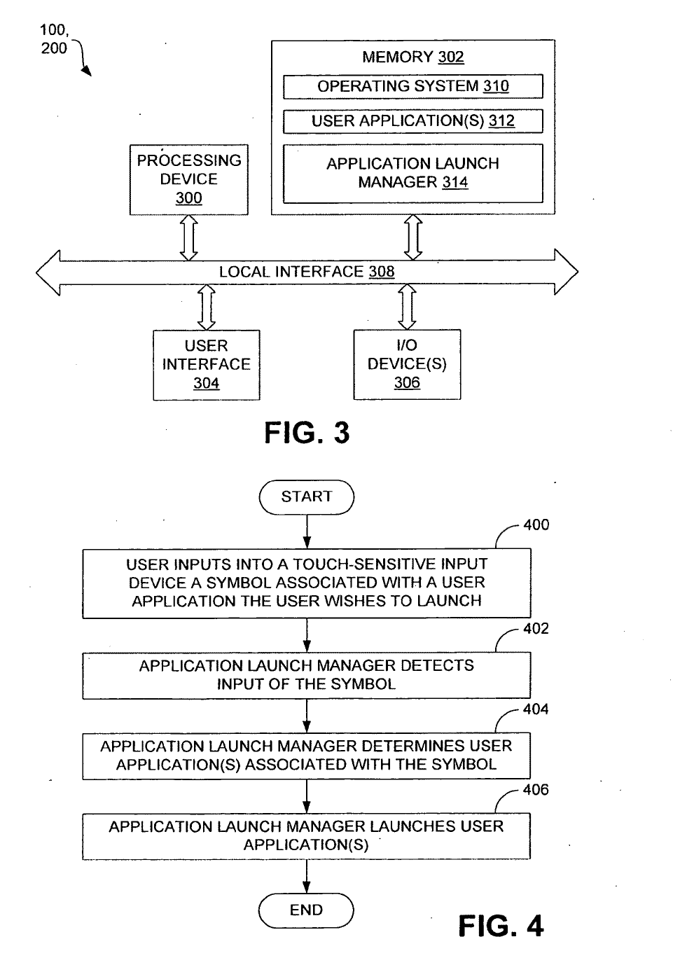

FIG. 3 is a block diagram illustrating an example architecture for one or both of the computing devices 100 and 200. As indicated in FIG. 3 the computing device 100, 200 comprises a processing device 300, memory 302, a user interface 304, and at least one I/O device 306, each of which is connected to a local interface 308.

The processing device 300 can comprise a central processing unit (CPU) that controls overall operation of the computing device 100, 200. The memory 302 includes any one of or a combination of volatile memory elements (e.g., RAM) and nonvolatile memory elements (e.g., hard disk, ROM, tape, etc.) that store code that can be executed by the processing device 300.

The user interface 304 comprises the components with which a user interacts with the computer 100, 200. The user interface 304 at least includes the touchpad 112 shown in FIG. 1 or the touch-sensitive display 210 shown in FIG. 2. In addition, the user interface 304 can comprise a keyboard and a mouse. The one or more I/O devices 306 are adapted to facilitate communications with other devices and may include one or more communication components such as a modulator/demodulator (e.g., modem), wireless (e.g., radio frequency (RF)) transceiver, network card, etc.

The memory 302 comprises various programs (i.e., logic) including an operating system 310 and one or more user applications 312. The operating system 310 controls the execution of other programs and provides scheduling, input-output control, file and data management, memory management, and communication control and related services. The user applications 312 can comprise any application that executes on the computing device 100, 200 that a user may wish to activate or launch. In some embodiments, two or more applications 312 are associated with each other to form a “suite” of applications that can be launched by the user.

The memory 302 further comprises an application launch manager 314 that comprises a program that detects user input in a touch-sensitive input device of a symbol that represents one or more user applications and, in response, launches the user application(s). Operation of the application launch manager 314 is described below in relation to FIGS. 4-7.

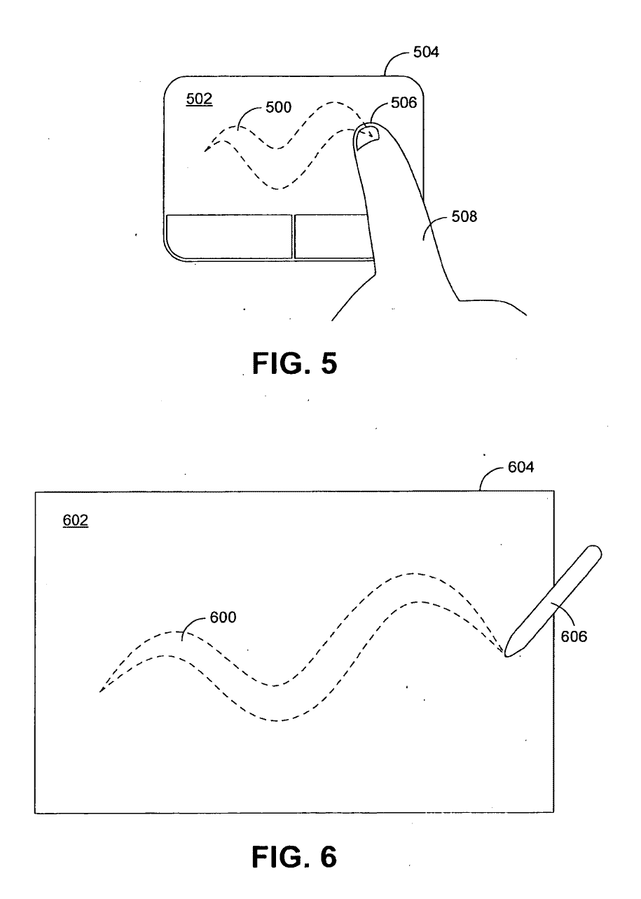

Referring next to FIG. 4, illustrated is an embodiment of a method for launching a user application. Beginning with block 400, a user inputs into a touch-sensitive input device of a computing device a symbol associated with a user application the user wishes to launch. By way of example, the symbol may be input into a touchpad of the computing device. Such input is depicted in FIG. 5. As illustrated in FIG. 5, the user has “written” a symbol 500 on a surface 502 of a touchpad 504 using a tip 506 of the user's index finger 508. Notably, the user does not literally write the symbol on the touchpad 504. Instead, the user merely traces out the shape of the symbol with his or her finger tip. In a further example, the symbol may be input into a touch-sensitive display of the computing device. Such input is depicted in FIG. 6. As illustrated in FIG. 6, the user has “written” a symbol 600 on a surface 602 of a touch-sensitive display 604 using a stylus 606. Again, the user does not literally write the symbol on the touch-sensitive display. Instead, the user merely traces out the shape of the symbol with the stylus 606.

In the examples of FIGS. 5 and 6, the symbol input by the user comprises a stylized “M” symbol. To form that symbol, the user first draws an input element (i.e., finger or stylus) up and to the right across the touch-sensitive input device. The user then, without lifting the input element, changes direction and draws the input element down and to the right across the touch-sensitive input device. Next, the user repeats both the upward and to the right and downward to the right strokes, again without lifting the input element, to complete the four legs of the “M.” In some embodiments, that symbol can be used to identify a suite a multimedia applications that are launched when the symbol is input. As is apparent from comparison of the symbols 500 and 600 of FIGS. 5 and 6, respectively, the size of the symbol may vary as long as the symbol has the same relative proportions. Furthermore, the location in which the symbol is input into the touch-sensitive input device is not critical. In addition, it is noted that although a finger 506 is shown inputting the symbol in the touchpad 504 and a stylus 606 is shown inputting the symbol in the touch-sensitive display 604, either input element, or another input element, may be used with either touch-sensitive input device.

With reference back to FIG. 4, the application launch manager 314 detects the input of the symbol, as indicated in block 402. The application launch manager 314 then determines the application or applications associated with the symbol, as indicated in block 404, and then launches the one or more applications for the user, as indicated in block 406. By way of example, the application launch manager 314 presents a main user interface screen of the one or more applications to the user in the display of the computing device upon launching the one or more applications.

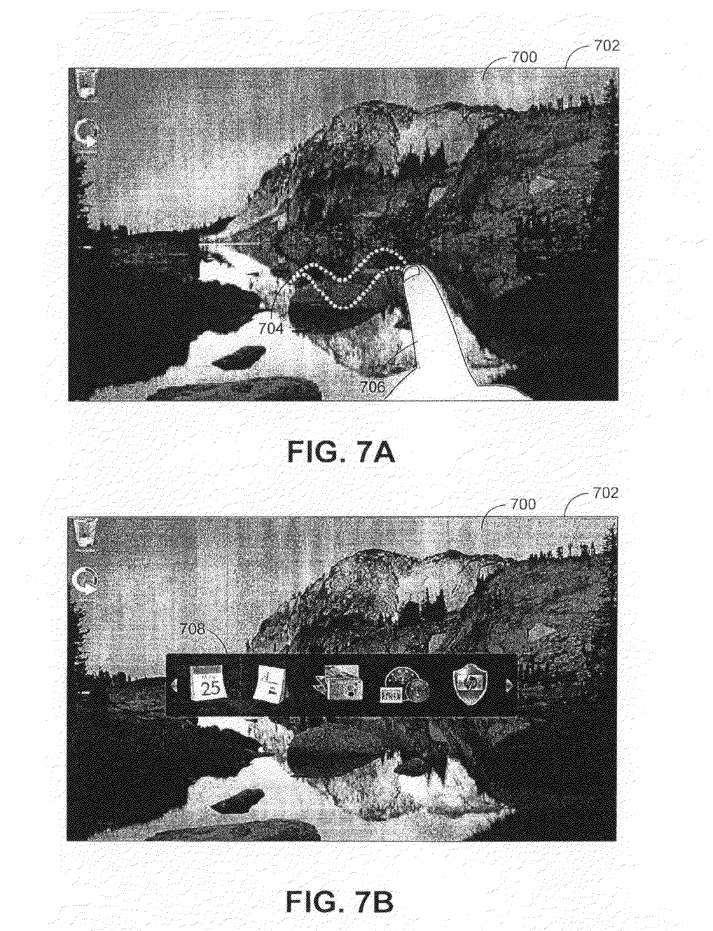

FIGS. 7A and 78 illustrate a specific example of launching a user application through input of a symbol into a touch-sensitive input device. Beginning with FIG. 7A, a desktop interface 700 is presented to a user in a touch-sensitive display 702. A user then inputs the stylized “M” symbol 704 into the touch-sensitive display 702 using his or her finger 706. Upon entry of that symbol 704, a multimedia application launches and a main screen of menu 708 of the application is presented to the user in the display 702, as indicated in FIG. 78. As is apparent from the example of FIGS. 7A and 78, launching of the application was achieved without use of an onscreen cursor or interacting with an icon or other displayed feature. Instead, the user simply input a symbol in an arbitrary portion of the touch-sensitive display 702 using with a short, continuous stroke of a finger.

Although a particular symbol has been described in the foregoing, it is to be understood that alternative symbols can be used, if desired. In some embodiments, the application launch manager of a computing device can be configured to recognize or detect the input of multiple different symbols, each pertaining to a different user application or set of user applications.

Claimed are:

1. A method for launching a user application on a computing device, the method comprising:
detecting user input of a symbol into a touch-sensitive input device of the computing device;
determining a user application associated with the input symbol; and
launching the user application.

2. The method of claim 1, wherein detecting user input comprises detecting user input of the symbol into a touchpad of the computing device.

3. The method of claim 1, wherein detecting user input comprises detecting user input of the symbol into a touch-sensitive display of the computing device.

4. The method of claim 1, wherein detecting user input comprises detecting input of the symbol by a finger.

5. The method of claim 1, wherein detecting user input comprises detecting input of the symbol by a stylus.

6. The method of claim 1, wherein detecting user input comprises detecting user input of a stylized “M” symbol.

7. The method of claim 1, wherein determining a user application associated with the input symbol comprises determining a set of user applications associated with the input symbol.

8. The method of claim 1, wherein launching the user application comprises presenting a user interface of the user application in a display of the computing device.

9. A computer-readable medium that stores an application launch manager, the application launch manager comprising:
logic configured to detect user input of a symbol into a touch-sensitive device of a computing device; and
logic configured to launch a user application associated with the symbol.

10. The computer-readable medium of claim 9, wherein the logic configured to detect user input comprises logic configured to detect user input of the symbol into a touchpad of the computing device.

11. The computer-readable medium of claim 9, wherein the logic configured to detect user input comprises logic configured to detect user input of the symbol into a touch-sensitive display of the computing device.

12. The computer-readable medium of claim 9, wherein the logic configured to detect user input comprises logic configured to detect user input of a stylized “M” symbol.

13. The computer-readable medium of claim 9, wherein the logic configured to launch the user application comprises logic configured to present a user interface of the user application in a display of the computing device.

14. A computing device comprising:
a processing device;
a touch-sensitive input device; and
memory that stores an application launch manager, the application launch manager being configured to detect user input of a symbol into the touch-sensitive input device and, responsive to that detection, launch a user application associated with the symbol.

15. The computing device of claim 14, wherein touch-sensitive input device comprises a touchpad of the computing device.

16. The computing device of claim 14, wherein touch-sensitive input device comprises a touch-sensitive display of the computing device.

17. The computing device of claim 14, wherein the application launch manager is configured to detect user input of a stylized “M” symbol.

18. The computing device of claim 14, wherein the user application is configured to present a user interface of the user application upon launching the user application.

19. The computing device of claim 14, wherein the computing device is a notebook computer.

20. The computing device of claim 14, wherein the computing device is a desktop computer.
